(19) United States
(12) Patent Application Publication
(10) Pub. No.: US 2026/0105195 A1
(43) Pub. Date: Apr. 16, 2026

(54) CONFIDENTIAL COMMUNICATION MONITORING AND NOTIFICATION

(71) Applicant: MASTERCARD ASIA/PACIFIC PTE. LTD.,, Singapore (SG)

(72) Inventors: Surbhi Malhotra, Pune (IN); Kaushal Shetty, O'Fallon, MO (US); Vijay Nath, Singapore (SG)

(21) Appl. No.: 18/917,223

(22) Filed: Oct. 16, 2024

(51) Int. Cl. G06F 21/74

(52) U.S. Cl. CPC G06F 21/74

(57) ABSTRACT

Systems and techniques are described for monitoring an environment during a confidential conversation and notifying a user when the confidential conversation is at risk of being compromised. In response to receiving a confidential communication monitoring session trigger for monitoring an environment in which a user is located, a confidential communication monitoring session can be initiated by requesting a monitoring device in the environment to activate a local kernel; and obtaining user identity information for users associated with a particular work profile associated with the user and the trigger. During the confidential communication monitoring session, sensor activity from at least a microphone is received; and the sensor activity is monitored for activity indicating a potential intruder in the environment and volume levels of the user's activities so as to keep work communications at sound levels sufficient for confidentiality requirements of the particular work profile.

### BACKGROUND

With the prevalence of teleworking and fully remote jobs, there has been a rise in concern over unintentional disclosures of confidential and/or sensitive information. Many home-office configurations make it difficult to ensure that confidential conversations are kept strictly confidential. It can also be difficult to keep conversations confidential in open plan office and cubicle settings, especially where certain topics of conversation may not be appropriate for every individual present in an office to overhear.

There are several risks to the potential disclosure of confidential conversations. For example, unwanted individuals may be within listening range, or the speaker may be speaking at a volume that makes the speaker's conversation easy to overhear. To keep conversations confidential in situations where passersby may overhear the conversation, the speaker currently must maintain sufficient awareness of their environment while engaging in a confidential conversation. It is up to the speaker to ensure that the conversation is not at risk of being overheard by others, which can be difficult in certain environments where the speaker has some impression of privacy and/or the speaker is focused on the conversation and not the environment.

### BRIEF SUMMARY

Confidential communication monitoring and notification are provided. Systems and techniques are described for monitoring an environment during a confidential conversation and notifying a user when the confidential conversation is at risk of being compromised. Advantageously, a confidential communication monitoring feature described herein utilizes sensors in an environment to actively monitor the environment of the user during a confidential conversation to detect potential intruders, monitor a volume of the user's speaking voice, and notify the user when the confidential conversation is at risk of being compromised.

A method of monitoring an environment can include receiving a confidential communication monitoring session trigger for monitoring an environment in which a user is located. The confidential communication monitoring session trigger is associated with a particular work profile associated with the user. In response to receiving the confidential communication monitoring session trigger, the method includes initiating the confidential communication monitoring session. Initiating the confidential communication monitoring session can include requesting a monitoring device in the environment to activate a local kernel; obtaining user identity information for users associated with the particular work profile. Then, during the confidential communication monitoring session, the method includes receiving sensor activity from at least a microphone; and monitoring the sensor activity for activity indicating a potential intruder in the environment and volume levels of the user's activities so as to keep work communications at sound levels sufficient for confidentiality requirements of the particular work profile.

In some aspects, the features described herein relate to a monitoring device or computer readable storage medium having instructions for a confidential communication monitoring feature stored thereon that when executed by a computing system, direct the computing system to perform the method of monitoring an environment including monitoring sensor activity for activity indicating a potential intruder in the environment and volume levels of the user's activities so as to keep work communications at sound levels sufficient for confidentiality requirements of the particular work profile.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example confidential communication monitoring session scenario.

FIG. 2A illustrates components of a monitoring device incorporating a confidential communication monitoring feature.

FIG. 2B is a process flow diagram for confidential communication monitoring in accordance with an example implementation with increased security.

FIG. 3A illustrates a method of confidential monitoring and notification.

FIG. 3B illustrates an example implementation of the method of FIG. 3A.

FIG. 4 illustrates a use case of a confidential communication monitoring session.

FIG. 5 illustrates a use case of a confidential communication monitoring session.

FIG. 6 illustrates a use case of a confidential communication monitoring session.

FIG. 7A illustrates an example confidential communication monitoring feature onboarding process.

FIG. 7B illustrates an example work profile view in a graphical user interface.

### DETAILED DESCRIPTION

Confidential communication monitoring and notification are provided. Systems and techniques are described for monitoring an environment during a confidential conversation and notifying a user when the confidential conversation is at risk of being compromised. Advantageously, a confidential communication monitoring feature described herein utilizes sensors in an environment to actively monitor the environment of the user during a confidential conversation to detect potential intruders, monitor a volume of the user's speaking voice, and notify the user when the confidential conversation is at risk of being compromised.

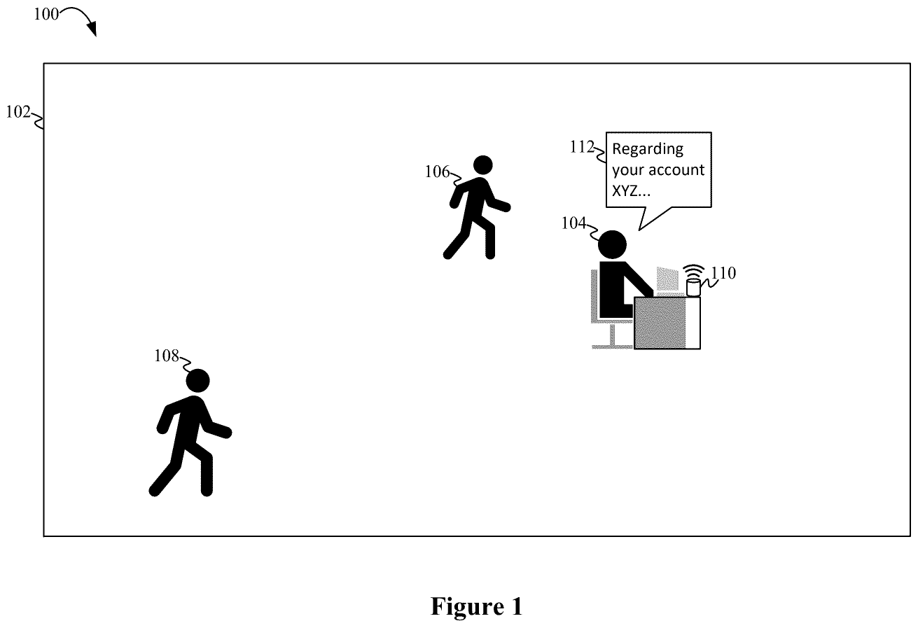

FIG. 1 illustrates an example confidential communication monitoring scenario. Referring to FIG. 1, example scenario 100 can include an environment 102, a user 104, a first intruder 106, a second intruder 108, and a monitoring device 110.

In example scenario 100, a user 104 may be involved in a confidential conversation 112 while working in environment 102 (e.g., an office space). It can be difficult for user 104 to vigilantly monitor the environment 102 for potential intruders that may be able to hear the confidential conversation 112, especially while staying engaged in the confidential conversation 112. Additionally, it can be easy for the volume of the speaker to rise to such a level that the confidential conversation 112 can be more easily overheard by intruders (e.g., first intruder 106 and/or second intruder 108).

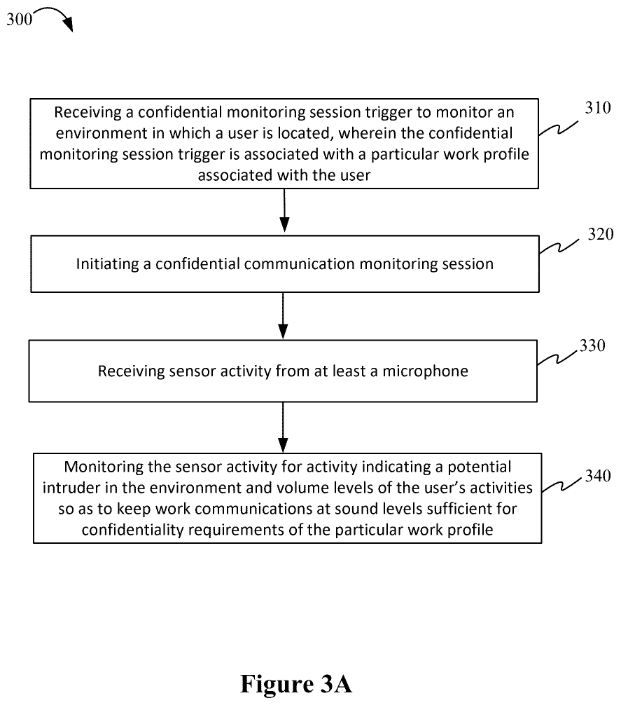

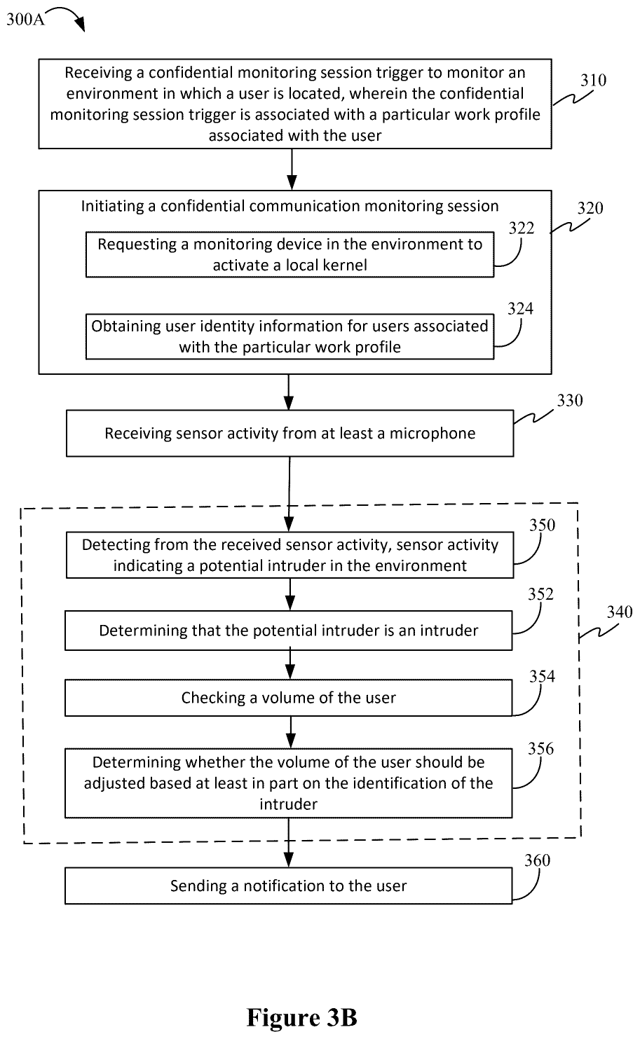

Advantageously, user 104 can utilize a confidential communication monitoring feature (e.g., operating on or with monitoring device 110) to monitor the environment 102 and to notify the user of potential confidentiality breaches. For example, as described with respect to FIGS. 3A-3B, the confidential communication monitoring feature operating on or with monitoring device 110 can detect the presence of the first intruder 106 and/or the second intruder 108 and notify the user 104 of potential risks, such as volume of user 104 and/or presence of intruder (e.g., first intruder 106 or second intruder 108), which can be based on intruder distance/positioning.

Monitoring device 110 is a computing device. In some cases, monitoring device 110 is a multi-function computing device such as a standard computer, tablet, laptop, mobile device, etc. In some cases, the monitoring device 110 can be a wearable device (e.g., Humane AI Pin, virtual reality headset, etc.). In some cases, the monitoring device 110 can be an internet-of-things (IOT) device. An IOT device is a hardware device that includes one or more sensors and a network interface to transmit data captured from the one or more sensors over the Internet. These devices are sometimes referred to as “smart” devices since they enable additional functionality and control as compared to how the device functions without the network connectivity. In many cases where the IOT device includes a personal digital assistant feature, a microphone is included as one of the one or more sensors. Examples of such IOT devices include Amazon Echo and Google Home. In these cases, the IOT device passively “listens” for a wake-up word and then upon detecting the wake-up word, begins recording and communicating information over the Internet via the Amazon Alexa and Google Assistant application programming interfaces to their services.

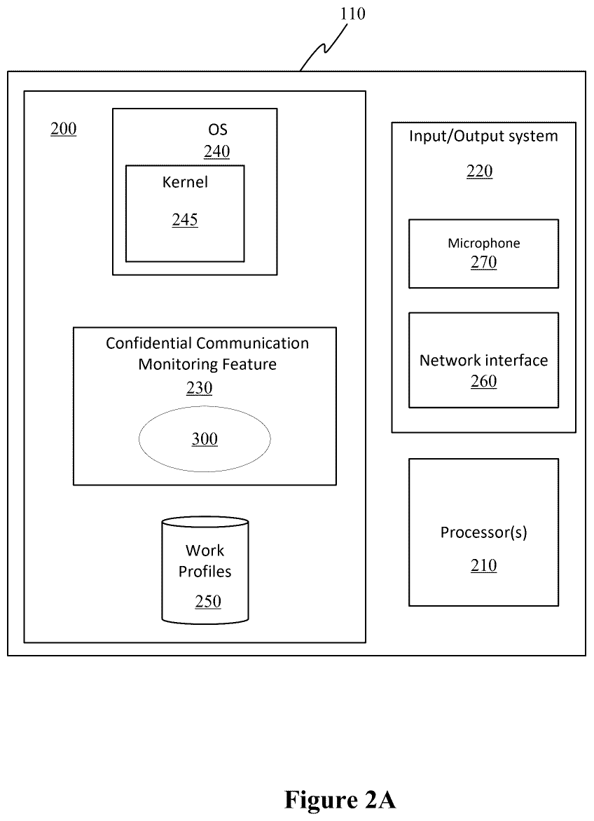

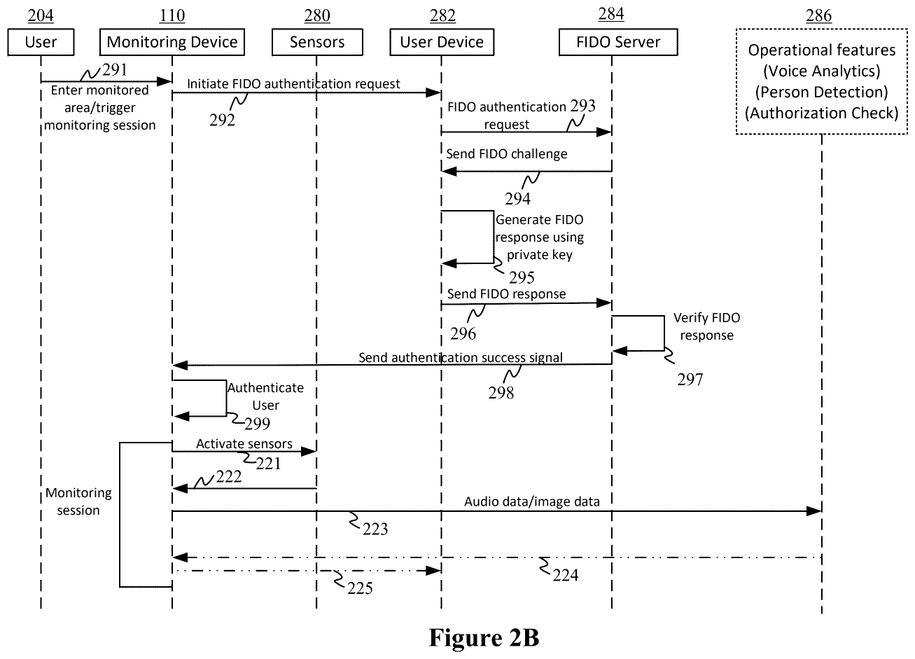

FIG. 2A illustrates components of a monitoring device 110 incorporating a confidential communication monitoring feature; and FIG. 2B is a process flow diagram for confidential communication monitoring in accordance with an example implementation with increased security.

Referring to FIG. 2A, monitoring device 110 includes memory 200, one or more processors 210, and an input/output system 220. Memory 200 can be implemented as one or more memory devices. Memory 200 stores instructions, including instructions for a confidential communication monitoring feature 230 (which can include instructions for performing method 300 such as described with respect to FIG. 3A and optionally FIG. 3B) and an operating system (OS) 240 with a kernel 245 that manages the operations of the monitoring device 110 including access to the various hardware devices of the monitoring device 110 by processes running on the monitoring device 110. Memory 200 can also store data, for example, work profiles 250 used by the confidential communication monitoring feature 230.

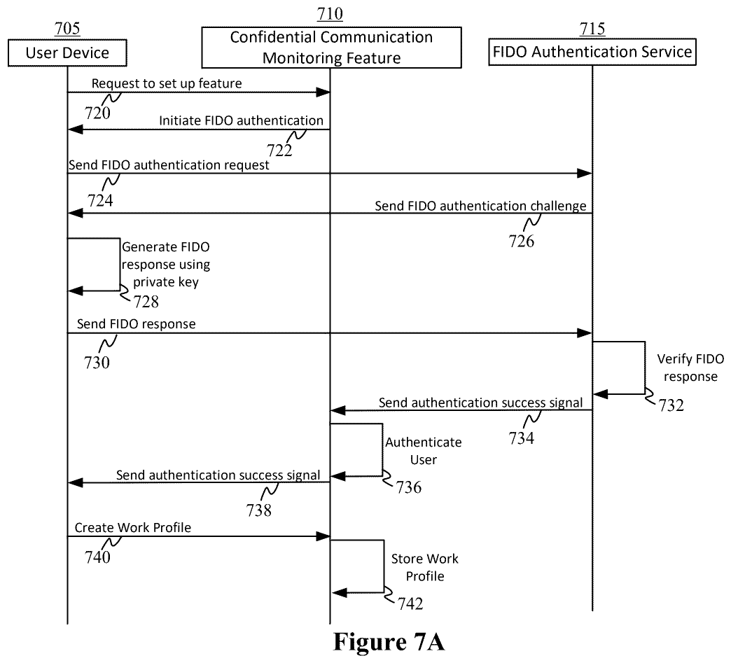

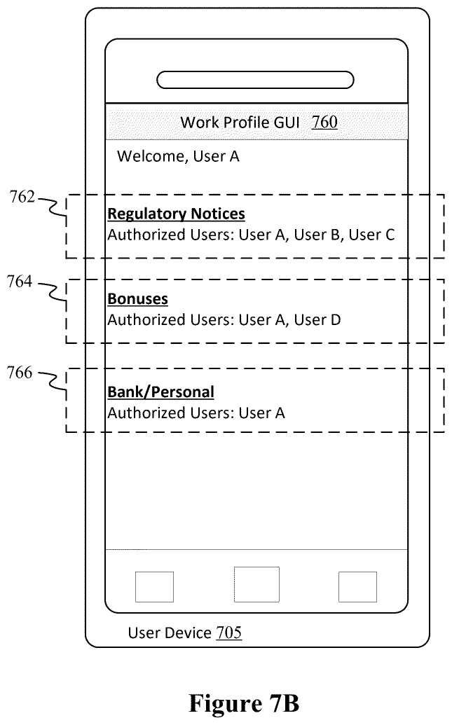

A “work profile” refers to the settings and information associated with a type or subject of work to which a set of rules related to the confidential communication monitoring feature can be applied. A user may have one or more work profiles for the confidential communication monitoring feature 230. Each work profile can include an indication of authorized users and potentially a level of security (e.g., privacy requirements and what unauthorized users may do). An authorized user is a user who is permitted (e.g., by the creator of a particular work profile) to listen to communications associated with that particular work profile. An unauthorized individual is an individual that is not designated as an authorized individual for a particular work profile. A user may set up one or more profiles (see e.g., FIGS. 7A-7B). In some cases, default work profiles may be available for the user to select and/or implement.

The confidential communication monitoring feature 230 can be software operating on the monitoring device 110 and may be integrated with monitoring device 110 as an inherent feature of monitoring device 110 or as a plug-in or extension for an existing application on the monitoring device 110.

Memory 200 may include volatile and nonvolatile memories, removable and non-removable media implemented in any method or technology for storage of information, such as computer readable instructions, data structures, program modules, or other data. Examples of memory 200 include random access memory, read only memory, magnetic disks, optical disks, CDs, DVDs, flash memory, magnetic disk storage or other magnetic storage devices, or any other suitable storage media. In no case is the storage medium a transitory propagated signal.

The one or more processors 210 can be one or more central processing units (CPUs), graphics processing units (GPUs), field programmable gate arrays (FPGAs), application specific integrated circuits (ASICs), or other processing unit or control circuit.

The input/output system 220 can include various systems and subsystems and components enabling input to and output from the monitoring device 110. For example, the input/output system 220 can include a network interface 260 (e.g., for wireless and/or wired communications) and a microphone 270 for receiving audio input. Other input and output interfaces and devices may be part of the input/output system 220. For example, interfaces and components for key input, mouse input, touch input, and motion input may be included. Network interface 260 can be used for communications with other computing devices in the environment or located remotely (e.g., on the cloud). For example, network interface 260 can be used to access remote services supporting voice analysis, person detection, and authorization checking when not available locally on the monitoring device 110. In addition, network interface 260 may be used to communicate with sensors in the environment. Communication to and from various components on and off monitoring device 110 may be carried out, in some cases, via application programming interfaces (APIs).

As illustrated in FIG. 2A, a confidential communication monitoring feature can be incorporated into a monitoring device. However, in some implementations, the confidential communication monitoring feature (e.g., as instructions stored in a memory that can be executed by a processor) is implemented on a separate computing device that is in communication with a monitoring device (e.g., via network interface 260 or other communications interface of input/output system 220). In addition, further layers of security and operations are possible. For example, referring to FIG. 2B, an example operating environment for confidential communication monitoring with additional security can include monitoring device 110, sensors 280, user device 282, FIDO server 284, and various modules or services (collectively referenced as operational features 286) that can be individually or separately variously executed by a processor of the monitoring device 110, the user device 282, or other device or server.

As shown in FIG. 2B, a user 204 entering a monitored area and/or triggering a confidential monitoring session is authenticated by the monitoring device 110 in cooperation with user device 282 (e.g., user's smartphone or computer), for example, using FIDO (fast identity online) authentication. FIDO authentication, developed by the FIDO Alliance, is a global authentication standard based on public key cryptography. A client device creates a new cryptographic key pair that is bound to a web service domain. The client device retains the private key and registers the public key with the online service. The cryptographic key pair is used to authenticate the client device (e.g., by a challenge and response) after local verification of the user via biometric, PIN, or FIDO security key. For example, monitoring device 110 initiates a FIDO authentication request (292) based on a user 204 entering a monitored area or triggering a monitoring session (291) by sending the request to a user device 282, which is set up as a client device for the FIDO authentication. User device 282 sends a FIDO authentication request (293) to the FIDO server 284, which issues a FIDO challenge (294). User device 282 generates the FIDO response using the private key (295) and sends the FIDO response (296) to the FIDO server 284, which verifies the FIDO response (297) and sends an authentication success signal (298) to the monitoring device 110 (directly or via user device 282). Here, the user device 282 supports the FIDO authentication; however, embodiments are not limited thereto and the monitoring device 110 may be the client device and/or may communicate with a different device supporting the FIDO authentication.

Once the user is authenticated (299), the monitoring device 110 can initiate the monitoring session for the user. For example, sensors 280 can be activated (221), and data from the sensors 280 can be received (222) at the monitoring device 110. Audio data and image data (e.g., “sensor activity”) received at the monitoring device 110 can undergo operations such as voice analytics, person detection, and authorization checking, for example, through operational features 286. Results of application of the operational features 286 can be provided (224) to the monitoring device 110 and, in some cases, communicated (225) to user device 282. In some cases, operational features 286 and/or monitoring device 110 include a communication feature that enables a message or notification to be sent over a communication channel to the user, for example, to the user device 282. Secure communication channels may be used. As previously mentioned, the services may be local on the monitoring device 110, located at user device (or other computing device in communication with monitoring device), or cloud-based.

As an illustrative example of applying operational features 286, monitoring device 110 can send audio data for voice analysis to a voice analytics service that may incorporate machine learning models for voice analysis, distinguishing between the profile owner's voice and others. In addition, monitoring device 110 can send image data for person detection to a video monitoring service that can include computer vision algorithms and, in some cases, geofencing techniques to assist with person detection based on location. Operational features 286 can also include an authorization check, which can provide a multi-factor authentication, combining voice recognition (e.g., of user 204 and/or any potential intruders) with additional factors such as secure tokens or biometric data associated with the work profiles 250.

FIG. 3A illustrates a method of confidential monitoring and notification. FIG. 3B illustrates an example implementation of the method of FIG. 3A.

Referring to FIG. 3A, method 300 can include receiving (310) a confidential communication monitoring session trigger to monitor an environment in which a user is located. The confidential communication monitoring session trigger is associated with a particular work profile associated with the user. The trigger may include a verbal ‘wake word’ that is received from a microphone associated with a monitoring device (e.g., microphone 270 of monitoring device 110). In some cases, the trigger may be audio received after a wake word is received at the monitoring device. Example phrases may include (but should not be construed as limiting): “Work Profile: Bank,” or “Alexa, Monitor Stocks”. In some cases, the audio is converted to text (e.g., via a speech to text service) and the trigger is received by the confidential communication monitoring feature as a string of text. In some cases, the trigger may be received via a key or touch input, for example, received via a graphical user interface (GUI) of an application at a user device or monitoring device. In some cases, the trigger may be received via a command initiated by another application (e.g., an online meeting/collaborative application may trigger the session when certain conditions are met).

In response to receiving the trigger, method 300 further includes initiating (320) a confidential communication monitoring session. During the confidential communication monitoring session, method 300 includes receiving (330) sensor activity from at least a microphone (e.g., microphone 270 of monitoring device 110). Sensor activity refers to the signals that can be captured by a sensor. The environment may have one or more different sensors that can capture activity. For example, at a minimum, the environment includes a microphone, which captures audio from the environment and generates audio signals. Other sensors that may be available in the environment include, but are not limited to, a camera and a motion detector. During the confidential communication monitoring session, method 300 further includes monitoring (340) the sensor activity for activity indicating a potential intruder in the environment and volume levels of the user's activities so as to keep work communications at sound levels sufficient for confidentiality requirements of the particular work profilc.

For example, as illustrated by method 300A in FIG. 3B, initiating (320) a confidential communication monitoring session can include: requesting (322) a monitoring device (e.g., monitoring device 110) in the environment to activate a local kernel (e.g., kernel 245); and obtaining (324) user identity information for users associated with the particular work profile.

Requesting (322) that the monitoring device 110 activate a local kernel at the monitoring device 110 can include instructions that the monitoring device 110 suspend Internet access of a basic kernel. The local kernel can have minimal resource consumption, focusing on real-time processing of received sensor data and voice inputs. In some cases, containerization techniques can be used to isolate monitoring processes from the primary device functions. Advantageously, by suspending Internet access of a basic kernel at the monitoring device 110 and isolating the monitoring processes from primary device functions, the confidentiality of communications in the environment are increased because input received at the monitoring device is prevented from being uploaded to the Internet (or otherwise shared/dispersed).

Obtaining (324) user identity information associated with the particular work profile can include obtaining stored biometric information of authorized users (e.g., voice biometrics, facial biometrics, iris biometrics, fingerprint biometrics, etc.). The identity information can be used to identify authorized users in environment during a confidential communication monitoring session. Authorized users associated with a particular work profile (and certain associated information) can be stored as part of work profiles 250 in memory 200.

Then, during the monitoring (340) of the sensor activity (e.g., as received (330) from at least a microphone), method 300A can include detecting (350), from the received sensor activity, sensor activity indicating a potential intruder in the environment; determining (352) that the potential intruder is an intruder; checking (354) a volume of the user; and determining (356) whether the volume of the user should be adjusted based at least in part on the identification of the intruder. When it is determined that the volume should be adjusted, the method can further include sending (360) a notification to the user that the intruder is in the environment and/or a notification that an adjustment to volume should be made.

Detecting (350) sensor activity indicating a potential intruder is in the environment can include detecting sensor activity that indicates that someone other than the user is in the environment. For example, audio captured by microphone 270 can be analyzed to identify sound levels above a certain background threshold. The sensor activity of the audio having sound levels above a certain background threshold may be separated into categories such as voices and other sounds, and the voices evaluated to determine whether the user is speaking or another person is speaking. Audio that is identified as having sound levels above the certain background threshold and that is not identified as being the voice of the user may indicate a potential intruder in the environment.

As previously mentioned, in some cases, in addition to a microphone 270, the environment can include a camera and/or motion sensor. In some of such cases, detecting (350) sensor activity indicating a potential intruder in the environment can include detecting from received sensor activity of one or more of auditory, visual, and motion detection data (e.g., identified from image data from the camera or from a dedicated motion sensor) that there is a potential intruder in the environment.

Once the sensor activity indicating a potential intruder in the environment is detected, determining (352) that the potential intruder is an intruder can include determining that the sensor activity corresponding to the potential intruder is indicative of a person; determining, from the sensor activity, an identity of the person; and determining that the identified person does not correspond to the user identity information for users associated with the particular work profile. An intruder is an individual that is not an authorized user associated with the work profile.

Determining, from the sensor activity, the identity of the person can include evaluating the sensor activity using identity information associated with a work profile. As previously mentioned, identity information can include, but is not limited to, biometric data, for example, voice biometrics, facial biometrics, iris biometrics, fingerprint biometrics, etc.). In some cases, evaluating the sensor activity using the identity information associated with a work profile includes comparing identity information of the potential intruder to identity information for people associated with the particular work profile to find a match.

If the potential intruder is determined to be a person having an identity that is part of the work profile (e.g., there is a match with respect to the identity information), then the potential intruder is not considered to be an intruder. If the potential intruder is determined to be a person that does not have a matching identity information in the work profile, then the potential intruder is determined to be an intruder.

Checking (354) the volume of the user can include determining a decibel level of a voice of the user captured by the microphone 270 as part of the sensor activity. In some cases, the confidential communication monitoring feature 230 can identify a voice of the user by the user identify information (e.g., auditory sample) stored with the particular work profile (e.g., work profiles 250 at memory 200) and performing a sound level analysis on the parts of the received audio identified as being the user.

Regarding determining (356) whether the volume of the user should be adjusted based at least in part on identification of the intruder, there are several factors that may be involved, including, but not limited to, the detection of the presence of the intruder (such as described with respect to determining (352) that the potential intruder is an intruder), the volume of the user (such as described with respect to checking (354) the volume of the user), the intruder's distance from the user (e.g., using image/video processing/person detection), and the user's orientation. For example, in some cases, merely detecting the presence of the intruder results in a determination that the volume of the user should be adjusted. In some cases, in addition to detecting the presence of the intruder, the volume of the user influences the determination of whether the volume of the user should be adjusted. In further cases, in addition to both the presence of the intruder and the volume of the user being considered for determining that the volume of the user should be adjusted, the intruder's distance from the user is considered in the determination as to whether the volume of the user should be adjusted. In some cases, the user's orientation is further included in the determination as the whether the volume of the user should be adjusted.

The intruder's distance from the user can be estimated based on a received sound associated with the intruder or by some other sensor activity (e.g., due to location of a particular sensor, estimated distance based on the image/video, etc.). Using the estimated intruder's distance and the detected volume of the user, it is possible to determine whether the intruder can overhear the user talking. In some cases, the confidential communication monitoring feature 230 can determine whether the intruder can overhear the user talking by using sound attenuation and the inverse square concept to estimate the distance that the sound of the user could reach with respect to the intruder. Sound attenuation is the decrease in sound intensity as it travels away from a source. As sound travels away from a sound source, the sound gets quieter. The inverse square law is a rule that describes how the intensity of sound changes with distance. The inverse square law states that the intensity of the sound is inversely proportional to the square of the distance from the source.

Accordingly, based on the calculated measurement for determining a distance that sound of the user could reach with respect to the intruder, the confidential communication monitoring feature 230 can determine if, based on a distance/position of an intruder in an environment, the user should adjust a volume of their voice to prevent confidential/sensitive information from being overheard.

Inverse square law can be expressed as intensity (I) varying as a function of distance (d) from some center. The intensity is proportional to the reciprocal of the square of the distance, thus:

$$intensity ∝ \frac{1}{{distance}^{2}}$$

For example, consider that a sound source is a user speaking in an office space. When an intruder is one meter away from the sound source, they can clearly hear the user speaking. However, if the intruder moves 2 meters away, the sound doesn't get half as loud; instead, the sound gets four times quieter.

To determine the distance that the sound of the user could reach, in some cases, the confidential communication monitoring feature 230 can calculate sound pressure level (Lp). Sound pressure level quantifies the pressure of a sound wave relative to a reference pressure, using logarithmic scale. Sound pressure level is used to calculate how the sound pressure level decreases as something (e.g., the intruder) moves away from a sound source (e.g., user).

The sound pressure level can be calculated using the equation: Lp(R2)=Lp(R1)−20·Log 10(R2/R1), where R1 is the initial distance from the sound source, and R2 is the distance at which the sound level is desired to be known. In the context of sound attenuation and the inverse square law, Lp represents the Sound Pressure Level (SPL). It is a measure of the pressure variation caused by a sound wave relative to a reference pressure level, typically measured in decibels (dB). The standard reference sound pressure (p0) in air is 20 μPA (microPascals), which is approximately the threshold of human hearing. For example, an initial distance R1 is 1 meter, the initial sound pressure level Lp(R1) is 90 dB at 1 meter. Using the formula Lp(R2)=Lp(R1)−20·log 10(R2R1): 90 dB−20·log 10(10)Lp(R2)=90 dB−20 dB Lp(R2)=70 dB. Therefore, at 10 meters, the sound pressure level is 70 dB.

As mentioned above, orientation of the user can be considered in determining whether the volume of the user should be adjusted. If the user is facing the potential intruder, then the distance of the potential intruder is the direct distance calculated using sound attenuation. If the user is not facing the potential intruder, then the angular distance is used instead. When the user is not facing the potential intruder, sound attenuation is affected by factors beyond just distance. The orientation of the speaker affects the directionality and dispersion of the sound. To calculate the sound attenuation in such a scenario, directivity, reflection and absorption, and diffraction are considered.

A user's voice can be modeled with different directional characteristics, often represented by a polar pattern or directivity pattern. Common patterns include omnidirectional, cardioid, and supercardioid. Each pattern describes how sound is distributed in different directions from the user. In some cases, to account for the fact that the user is not facing the potential intruder, a directivity index (DI) of the user and polar response data can be used. The DI indicates how much sound is focused in a particular direction compared to an omnidirectional source. Reflection and absorption include considering how sound waves interact with surfaces and materials in the environment. Diffraction includes considering how sound bends around obstacles. These factors can be calculated by the confidentiality communication monitoring feature using any method for calculating reflection and absorption and diffraction.

An example process for calculating sound attenuation using additional factors can include determining the user's polar response. Polar response can be obtained from a polar response chart or data for the user. The polar response shows the sound level output at various angles from the user's axis. Then, the angle between the user's front (on-axis) and the direction to the potential intruder are identified. The attenuation at the angle is found using the polar response chart to determine the attenuation (reduction in sound level) at the specific angle. Then, on-axis sound pressure level (Lp(R1) is calculated. To calculate the on-axis sound pressure level, the SPL is measured (or otherwise known) at a reference distance directly in front of the user (on axis). Then, distance-based attenuation is calculated using the inverse square law. Finally, the directional attenuation and distance attenuation are combined, Lp(R2)=Lp(R2) on-axis-Directional Attenuation, where Directional Attenuation is the attenuation from the polar response chart at the identified angle.

If it is determined that the volume of the user should be adjusted, the confidential communication monitoring feature 230 can send (360) a notification to the user. In some cases, the notification can include indication of the presence of the intruder. In some cases, sending (360) the notification to the user can include notifying the user to lower the volume of the user's voice. In some cases, the confidential communication monitoring feature 230 can send (360) a notification to the user via speakers at the monitoring device. In some cases, the confidential communication monitoring feature 230 can send (360) a notification to the user via a message sent to a user device.

As an illustrative scenario, a third party monitoring device (e.g., Amazon Alexa) can be used by activating a local kernel and performing a method including analyzing conversation of the user and dynamically selecting a confidential work profile associated with the conversation in response to identifying a trigger from the analyzed conversation. The selected confidential work profile can indicate a plurality of users associated therewith. These users may be authenticated using FIDO authentication prior to association with the confidential work profile. During the monitoring session, the voice of the user and the work environment is continuously monitored to detect an intruder. If an intruder is detected, the intruder identity is analyzed using the FIDO authenticated work profiles of the users associated with the selected confidential work profile and a match is determined using one of the FIDO authentication techniques. The decibel value of the user voice conversation is monitored and, using sound attenuation-inverse square law concept, an approximate distance of the intruders can be calculated when the intruder is not associated with the confidential work profile. In addition, sound source distance estimation may be used that involves a deep learning mechanism for the distance and/or using various sensors such as distance/IR sensors. For example, input of acoustic records can be analyzed for room acoustics and auditory models. Attributes for room acoustics include sound pressure level, autocorrelation, and spectral centroid. Attributes for auditory models include loudness, pitch, and sharpness. Perceptual thresholds applied using perceptual measures as input to local linear psychometric function from auditory models and used with loudness threshold, pitch threshold, sharpness threshold, and distance threshold for room acoustics. The user can be alerted to lower the decibel value when the intruder not associated with the confidential work profile is at a distance that is identified to be within hearing.

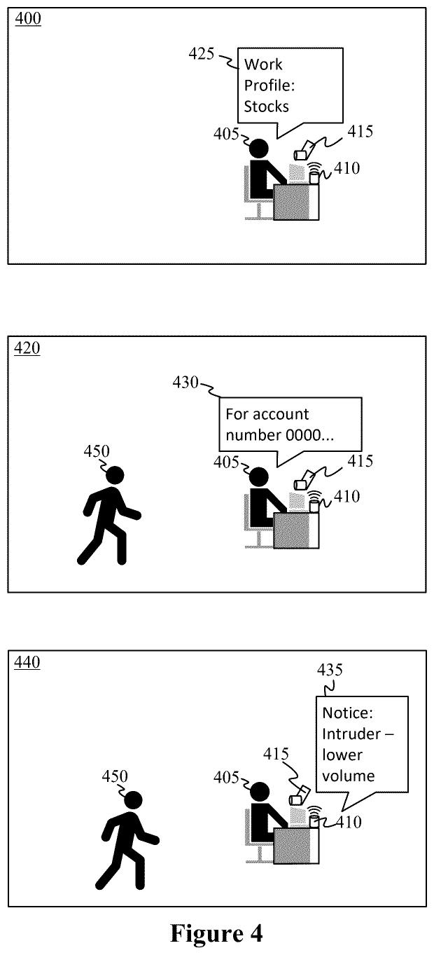

FIG. 4 illustrates a use case of a confidential communication monitoring session. Referring to FIG. 4, the first panel 400 illustrates a scene where a first character 405 triggers the monitoring device 410 to begin a confidential communication monitoring session by the audible statement 425 “Work Profile: stocks.” In response to this trigger, the monitoring device 410 (e.g., via a confidential communication monitoring feature) can initiate a confidential communication monitoring session associated with the work profile “stocks,” which can include rules and information related to who may overhear the conversation. The work profile, “stocks”, can indicate a single authorized user, where this authorized user is the first character 405.

The scenario continues in the second panel 420, in which a second character 450 enters the environment while the first character 405 is speaking 430. Because the monitoring device 410 is operating during confidential communication monitoring session, the monitoring device 410 is receiving sensor activity from the available sensor(s), for example, from a microphone in the monitoring device 410 and/or video from camera 415.

As such, the monitoring device 410 can detect, from received sensor activity, that the second character 450 is within the environment and is a potential intruder.

Monitoring device 410 (e.g., via confidential communication monitoring feature) can analyze the sensor activity to determine an identity of the second character 450 and to determine whether the identity of the second character 450 corresponds with user identity information for users associated with the work profile “stocks” associated with the confidential communication monitoring session.

In addition, the monitoring device 410 (e.g., via confidential communication monitoring feature) can check a speaking volume of the first character 405 to determine if the first character 405 is speaking at a volume that may be overheard by the second character 450.

As shown in the third panel 440, the monitoring device provides a notification 435 to the first character 405 in response to the identification of the second character 450 as an intruder (e.g. not a user associated with the work profile “stocks”) and the volume level of the first character's conversation. Here, the notice recommends that the first character 405 lower their volume.

A confidential communication monitoring feature (e.g., operating on the monitoring device 410) may perform method 300 (and in some cases as described with respect to method 300A) to facilitate the use case described with respect to FIG. 4. For example, as shown in the first panel 400, when the confidential communication monitoring feature receives the audible statement 425 “Work Profile: stocks,” the confidential communication monitoring feature is receiving a confidential communication monitoring session trigger to monitor an environment, wherein the confidential communication monitoring session trigger is associated with a particular work profile (e.g., “stocks”), and wherein a user associated with the particular work profile is in the environment (e.g., first character 405).

In response to receiving the confidential communication monitoring session trigger, the confidential communication monitoring feature can initiate a confidential communication monitoring session by requesting that the monitoring device 410 in the environment activate a local kernel and obtaining user identity information for users associated with the particular work profile of labeled “stocks.” In this case, the user identity information includes user identity information for the first character 405. This can include a voice sample for the first character 405, which facilitates the identification of first character 405 by the confidential communication monitoring feature.

In the use case illustrated in FIG. 4, as shown in the second panel 420 the second character 450 enters the environment during the confidential communication monitoring session. The confidential communication monitoring feature is receiving sensor activity from a plurality of sensors, for example camera 415 and monitoring device 410. From the sensor activity, the confidential communication monitoring feature can detect sensor activity indicating a potential intruder (e.g., the second character 450) is in the environment. For example, the sensor activity indicating that the second character 450 is in the environment can include audio data of a voice that is distinct from the voice of the first character 405.

The confidential communication monitoring feature can analyze the sensor activity indicating the second character 450 to determine an identity of the second character 450. For example, in this use case, the confidential communication monitoring feature can compare the detected voice of the second character to user identity information for users associated with the particular work profile “stocks.” In this case, the second character 450 is not an authorized user for the work profile “stocks” and therefore, there is no user identity information corresponding to the second character 450. The confidential communication monitoring feature can determine that the second character 450 is an intruder.

Before, during, or subsequent to determining that the second character 450 is an intruder, the confidential communication monitoring feature can check a volume of the first character 405.

Once the confidential communication monitoring feature has checked a volume of the first character 405, the confidential communication monitoring feature can determine whether the volume of the first character 405 should be adjusted based at least in part on the identification of the second character 450 as an intruder. In some cases, the identification of the second character 450 as an intruder is sufficient to result in a determination that the volume of the first character 405 should be adjusted. In the illustrated case, the volume of the first character 405 and a distance of the second character 450 from the first character 405 are part of the determination regarding adjustment of the volume. For example, the determination can involve calculating sound attenuation. Based on the distance of the second character 450 and the volume of the first character 405, the confidential communication monitoring feature may determine that, based on the volume of the first character 405, at the determined distance, the second character 450 can hear the voice of the first character 405. The confidential communication monitoring feature can then send a notification to the first character 405 (e.g., notification 435) to notify the first character 405 of the presence of the second character 450 and to recommend that the first character 405 lower their volume.

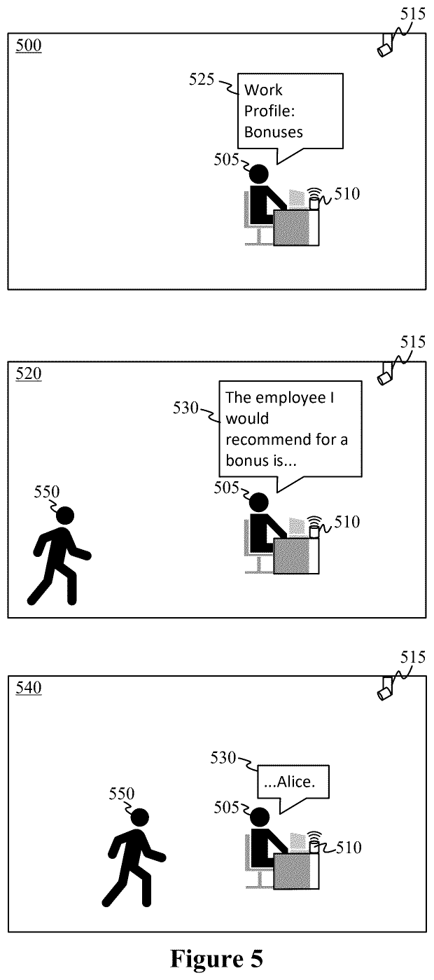

FIG. 5 illustrates a use case of a confidential communication monitoring session. Referring to FIG. 5, the first panel 500 illustrates a scene where a first character 505 triggers the monitoring device 510 to begin a confidential communication monitoring session via the audible statement 525 “Work Profile: Bonuses.” In response to this trigger, the monitoring device 510 (e.g., via a confidential communication monitoring feature) can initiate a confidential communication monitoring session associated with the work profile “bonuses,” Which can include rules and information related to who may overhear the conversation. The work profile, “bonuses”, can indicate multiple authorized users, for example the first character 505 and a second character 550.

The scenario continues in the second panel 520, in which the second character 550 enters the environment while the first character 505 is speaking 530. Because the monitoring device 510 is operating during a confidential communication monitoring session, the monitoring device 510 is receiving sensor activity from the available sensor(s), for example, for example, from a microphone in the monitoring device 510 and/or video from camera 515.

As such, the monitoring device 510 can detect, from received sensor activity, that the second character 550 is within the environment and is a potential intruder.

Monitoring device 510 (e.g., via confidential communication monitoring feature) can analyze the sensor activity to determine an identity of the second character 550 and to determine whether the identity of the second character 550 corresponds with user identity information for users associated with the work profile “bonuses” associated with the confidential communication monitoring session. In this case, the second character 550 is an authorized user for the work profile “bonuses.” Therefore, the user identity information for users associated with the work profile “bonuses” would match the individuals identified through analysis of the sensor activity, including that the potential intruder of the second character 550 is not an intruder.

In some cases, no check of the volume of the first character 505 is performed. However, in other cases, the volume of the first character is monitored on a regular or periodic basis. to determine if the first character 505 is speaking at a volume with the potential to be overheard (and in some cases at what distance the first character 505 may be overheard).

As shown in the third panel 540, because the second character 550 was identified as an authorized user, the monitoring device 510 does not provide any notification. As such, the first character 505 can continue without concern.

A confidential communication monitoring feature (e.g., operating on the monitoring device 510) may perform method 300 (and in some cases as described with respect to method 300A) to facilitate the use case described with respect to FIG. 5. For example, as shown in the first panel 500, when the confidential communication monitoring feature receives the audible statement 425 “Work Profile: bonuses,” the confidential communication monitoring feature is receiving a confidential communication monitoring session trigger to monitor an environment, wherein the confidential communication monitoring session trigger is associated with a particular work profile (e.g., “bonuses”), and wherein a user associated with the particular work profile is in the environment (e.g., first character 505).

In response to receiving the confidential communication monitoring session trigger, the confidential communication monitoring feature can initiate a confidential communication monitoring session by requesting that the monitoring device 510 in the environment activate a local kernel and obtaining user identity information for users associated with the particular work profile of labeled “bonuses.” In this case, the user identity information includes user identity information for the first character 505 and user identity information for the second character 550, because both the first character 505 and the second character 550 are authorized users for the work profile “bonuses”. The user identity information can include a voice sample for the first character 505, which facilitates the identification of first character 505 by the confidential communication monitoring feature. The user identity information can also include a voice sample for the second character 550.

In the use case illustrated in FIG. 5, as shown in the second panel 520 the second character 550 enters the environment during the confidential communication monitoring session. The confidential communication monitoring feature is receiving sensor activity from a plurality of sensors, for example camera 515 and monitoring device 510. From the sensor activity, the confidential communication monitoring feature can detect sensor activity indicating a potential intruder (e.g., the second character 550) is in the environment. For example, the sensor activity indicating that the second character 550 is in the environment can include audio data of a voice that is distinct from the voice of the first character 505.

The confidential communication monitoring feature can analyze the sensor activity indicating the second character 550 to determine an identity of the second character 550. For example, in this use case, the confidential communication monitoring feature can compare the detected voice of the second character to user identity information for users associated with the particular work profile “bonuses.” In this case, the second character 550 is an authorized user for the work profile “bonuses” and therefore, there is user identity information corresponding to the second character 550. The confidential communication monitoring feature can determine that the second character 550 is not an intruder. In some cases, the operations with respect to this instance of potential intruder detection may cease and the confidential communication monitoring session operations revert back to monitoring sensor activity for activity indicating a potential intruder in the environment and volume levels of the user's activities.

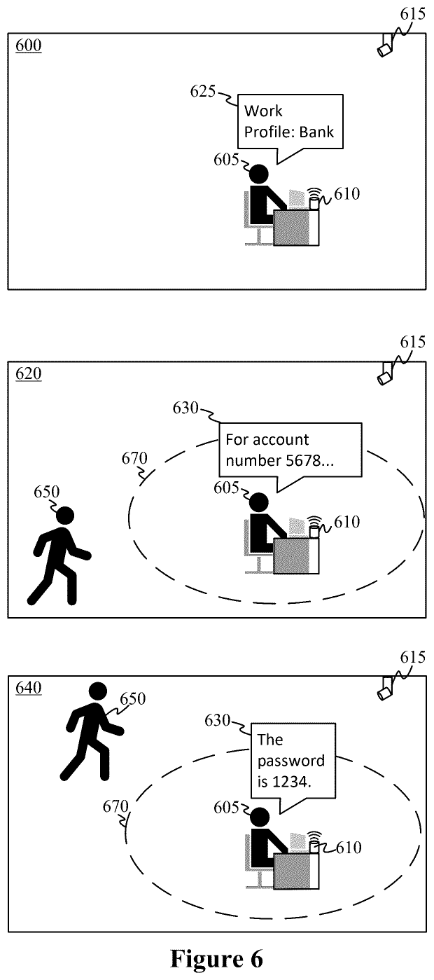

FIG. 6 illustrates a use case of a confidential communication monitoring session. Referring to FIG. 6, the first panel 600 illustrates a scene where a first character 605 triggers the monitoring device 610 to begin a confidential communication monitoring session via the audible statement 625 “Work Profile: Bank.” In response to receiving this trigger, the monitoring device 610 (e.g., via a confidential communication monitoring feature) can initiate a confidential communication monitoring session associated with the work profile “bank,” which can include rules and information related to who may overhear the conversation. The work profile “bank”, can indicate a single authorized user, where this authorized user is the first character 605.

The scenario continues in the second panel 620, in which a second character 650 enters the environment while the first character 605 is speaking 630. Because the monitoring device 610 is operating during a confidential communication monitoring session, the monitoring device 610 is receiving sensor activity from the available sensor(s), for example, for example, from a microphone in the monitoring device 610 and/or video from camera 615.

As such, the monitoring device 610 can detect, from received sensor activity, that the second character 650 is within the environment and is a potential intruder. Then, the monitoring device 610 (e.g., via confidential communication monitoring feature) can analyze the sensor activity indicating the presence of the second character 650 to determine an identity of the second character 650 and to determine whether the identity of the second character 650 corresponds with user identity information for users associated with the work profile “bank” associated with the confidential communication monitoring session. In this case, the second character 650 is not an authorized user for the work profile “bank” and the confidential communication monitoring feature determines that the potential intruder is an intruder.

Once it is determined that the potential intruder is an intruder, the confidential communication monitoring feature can check a speaking volume of the first character 605 to determine if the first character 605 is speaking at a volume with the potential to be overheard by the intruder. This operation includes determining a distance at which the volume is sufficiently attenuated.

In this use case, the monitoring device 610 can determine a distance of the second character 650 from the first character 605. Then, based on the distance of the second character 650 from the first character 605 and the volume of the first character 605 (including attenuation over distance), the confidential communication monitoring feature determines that the second character 650 cannot overhear the conversation 630. Indeed, the monitoring device 610 can determine that only individuals within outline 670 are within a range to overhear the conversation 630 of the first character 605. Therefore, even though the second character is an intruder, the monitoring device 610 does not notify the first character 605, and the first character 605 can continue the conversation 630, as shown in the third panel 640.

FIG. 7A illustrates an example confidential communication monitoring feature onboarding process. Referring to FIG. 7A, the onboarding process can begin when a user, via a user device 705, requests (720) to set up a confidential communication monitoring feature 710. In some cases, the user can register via an application or interface to a monitoring device supporting a confidential communication monitoring feature 710 on a user device 705. In some cases, the user can initiate registration/set up directly via a monitoring device incorporating the confidential communication monitoring feature (e.g., monitoring device 110).

As part of the set-up, the confidential communication monitoring feature 710 initiates (722) a FIDO authentication at the user device 705. The user device 705 sends (724) a FIDO authentication request to a FIDO authentication service 715. The FIDO authentication service 715 sends (726) a FIDO authentication challenge to the user device 705. The user device 705 generates (728) a FIDO response using a private key. Then, the user device 705 sends (730) the generated (728) FIDO response to the FIDO authentication service 715.

Advantageously, the generated (728) FIDO response can include user identifying information (e.g., biometric data), which can be used by the confidential communication monitoring feature 710 to facilitate the methods and process described with respect to FIGS. 3A-3B.

The FIDO authentication service 715 verifies (732) the FIDO response. In response to verifying (732) the FIDO response, the FIDO authentication service 715 sends (734) an authentication success signal to the confidential communication monitoring feature 710.

Once the confidential communication monitoring feature 710 receives the authentication success signal, the confidential communication monitoring feature 710 authenticates (736) the user. In some cases, the confidential communication monitoring feature 710 sends (738) an authentication success signal to the user device 705.

Once the user is authenticated at the confidential communication monitoring feature 710, the user, via the user device 705, can create (740) a work profile at the confidential communication monitoring feature 710. The work profile can include details such as a title/work profile name and user information. In some cases, the work profile can include user information for a plurality of users. In some cases, each of the plurality of users identified in a particular work profile are authenticated through the FIDO authentication service 715. The confidential communication monitoring feature 710 can store (742) the work profile information, for example, as part of work profiles 250 in a memory 200 such as described with respect to FIG. 2A.

FIG. 7B illustrates an example work profile view in a graphical user interface. Referring to FIG. 7B, a graphical user interface (GUI) 760 can display a work profile view providing details for a plurality of work profiles. In the example view, the work profiles are displayed for a particular user (e.g., User A). As shown in the example GUI 760, User A is associated with the “regulatory notices” 762 work profile, the “bonuses” 764 work profile, and the “bank/personal” 766 work profile.

In this example, User A has registered to create an account with a confidential communication monitoring feature (e.g., via the set-up process described with respect to FIG. 7A). Once registered, User A can create work profiles (e.g., as shown in GUI 760) designating the individuals with permitted to hear conversations occurring during a confidential communication monitoring session associated with the particular work profile. By designating authorized users with a particular work profile, the confidential communication monitoring feature will be able to monitor an environment for individuals who are not authorized for a particular work profile (i.e., intruders).

For example, if User A prompts a confidential communication monitoring feature to initiate a confidential communication monitoring session for the “regulatory notices” 762 work profile, the confidential communication monitoring feature would monitor for and determine that any detected individuals who are not User A, User B, or User C are intruders. Advantageously, if the confidential communication monitoring feature detects an individual other than User A, User B, or User C, the confidential communication monitoring feature can notify User A that the conversation is no longer confidential.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method, comprising:
receiving a confidential communication monitoring session trigger for monitoring an environment in which a user is located, wherein the confidential communication monitoring session trigger is associated with a particular work profile associated with the user;
in response to receiving the confidential communication monitoring session trigger, initiating the confidential communication monitoring session, wherein initiating the confidential communication monitoring session comprises:
requesting a monitoring device in the environment to activate a local kernel; and
obtaining user identity information for users associated with the particular work profile; and
during the confidential communication monitoring session:
receiving sensor activity from at least a microphone; and
monitoring the sensor activity for activity indicating a potential intruder in the environment and volume levels of the user's activities so as to keep work communications at sound levels sufficient for confidentiality requirements of the particular work profile.

2. The method of claim 1, wherein monitoring the sensor activity for activity indicating the potential intruder in the environment and the volume levels of the user's activities so as to keep work communications at sound levels sufficient for confidentiality requirements of the particular work profile comprises:
detecting, from the received sensor activity, sensor activity indicating a potential intruder is in the environment;
determining that the potential intruder is an intruder, wherein determining that the potential intruder is an intruder comprises determining that an identity of the potential intruder does not correspond to the user identity information for users associated with the particular work profile;
checking a volume of the user;
determining whether the volume of the user should be adjusted based at least in part on identification of the intruder; and
sending a notification to the user.

3. The method of claim 2, wherein checking a volume of the user comprises monitoring a decibel level of a voice of the user;
wherein determining whether the volume of the user should be adjusted based at least in part on identification of the intruder comprises determining that the decibel level of the voice of the user is beyond a particular threshold; and
wherein sending a notification to the user comprises notifying the user to lower the volume of the user.

4. The method of claim 3, wherein monitoring a decibel level of the voice of the user comprises calculating a sound pressure level for the voice of the user.

5. The method of claim 3, further comprising:
determining a distance of the intruder from the user; and
calculating, using the inverse square law, a distance a sound of the voice of the user could reach;
wherein determining whether the volume of the user should be adjusted is based in part on the distance of the intruder from the user and the distance the voice of the user could reach.

6. The method of claim 2, further comprising:
detecting, from the received sensor activity, second sensor activity indicating a second potential intruder is in the environment;
analyzing the second sensor activity indicating the second potential intruder to determine whether the second potential intruder is an intruder; and
determining that the second potential intruder is not an intruder, wherein determining that the second potential intruder is not an intruder comprises determining that an identity of the second potential intruder does correspond to the user identity information for users associated with the particular work profile.

7. The method of claim 1, wherein the confidential communication monitoring trigger is an audible trigger.

8. The method of claim 1, wherein the confidential communication monitoring trigger is a message from a user device.

9. The method of claim 1, wherein the user identity information comprises voice samples for each of the users associated with the particular work profile.

10. The method of claim 1, wherein each of the users associated with the particular work profile are authenticated via a FIDO authentication service.

11. A computer readable storage medium having instructions of a confidential communication monitoring feature stored thereon that when executed by a computing system, direct the computing system to at least:
receive a confidential communication monitoring session trigger for monitoring an environment in which a user is located, wherein the confidential communication monitoring session trigger is associated with a particular work profile associated with the user;
in response to receiving the confidential communication monitoring session trigger, initiate the confidential communication monitoring session, including to at least:
request a monitoring device in the environment to activate a local kernel; and
obtain user identity information for users associated with the particular work profile; and
during the confidential communication monitoring session to at least:
receive sensor activity from at least a microphone; and
monitor the sensor activity for activity indicating a potential intruder in the environment and volume levels of the user's activities so as to keep work communications at sound levels sufficient for confidentiality requirements of the particular work profile.

12. The computer readable storage medium of claim 11, wherein the instructions to monitor the sensor activity for activity indicating the potential intruder in the environment and the volume levels of the user's activities so as to keep work communications at sound levels sufficient for confidentiality requirements of the particular work profile, direct the computing system to at least:
detect, from the received sensor activity, sensor activity indicating a potential intruder is in the environment;
determine that the potential intruder is an intruder, wherein instructions to determine that the potential intruder is an intruder direct the confidential communication monitoring feature to at least determine that an identity of the potential intruder does not correspond to the user identity information for users associated with the particular work profile;
check a volume of the user;
determine whether the volume of the user should be adjusted based at least in part on identification of the intruder; and
send a notification to the user.

13. The computer readable storage medium of claim 11, wherein the instructions further direct the computing system to at least:
monitor a decibel level of a voice of the user; and
wherein the instructions to determine whether the volume of the user should be adjusted based at least in part on identification of the intruder direct the confidential communication monitoring feature to determine that the decibel level of the voice of the user is beyond a particular threshold; and
wherein the instructions to send a notification to the user direct the confidential communication monitoring feature to notify the user to lower the volume of the user.

14. The computer readable storage medium of claim 13, wherein the instructions to monitor a decibel level of the voice of the user instruct the computing system to calculate a sound pressure level for the voice of the user.

15. The computer readable storage medium of claim 13, wherein the instructions further direct the computing system to at least:
determine a distance of the intruder from the user; and
calculate, using the inverse square law, a distance a sound of the voice of the user could reach;
wherein the instructions to determine whether the volume of the user should be adjusted are based in part on the distance of the intruder from the user and the distance the voice of the user could reach.

16. The computer readable storage medium of claim 11, wherein the instructions further direct the computing system to at least:
detect, from the received sensor activity, second sensor activity indicating a second potential intruder is in the environment;
analyze the second sensor activity indicating the second potential intruder to determine whether the second potential intruder is an intruder; and
determine that the second potential intruder is not an intruder, wherein the instructions to determine that the second potential intruder is not an intruder direct the computing system to determine that an identity of the second potential intruder does correspond to the user identity information for users associated with the particular work profile.

17. The computer readable storage medium of claim 11, wherein the confidential communication monitoring trigger is an audible trigger.

18. The computer readable storage medium of claim 11, wherein the confidential communication monitoring trigger is a message from a user device.

19. A monitoring device comprising:
a processor;
a memory;
an operating system stored on the memory; and
instructions for a confidential communication monitoring feature stored on the memory that when executed by the processor, direct the monitoring device to at least:
receive a confidential communication monitoring session trigger for monitoring an environment in which a user is located, wherein the confidential communication monitoring session trigger is associated with a particular work profile associated with the user;
activate, by the operating system a local kernel;
obtain user identity information for users associated with the particular work profile;
receive sensor activity from at least a microphone;
detect, from the received sensor activity, sensor activity indicating a potential intruder is in the environment;
determine that the potential intruder is an intruder, including to at least determine that an identity of the potential intruder does not correspond to the user identity information for users associated with the particular work profile;
check a volume of the user;
determine whether the volume of the user should be adjusted based at least in part on identification of the intruder; and
send a notification to the user.

20. The monitoring device of claim 19, wherein the monitoring device comprises an interactive voice assistant device.
